(19) United States
(12) Patent Application Publication
(10) Pub. No.: US 2026/0285244 A1
(43) Pub. Date: Sep. 24, 2026

(54) REMOVABLE LICENSE PLATE MOUNTING ASSEMBLY

(71) Applicant: FCA US LLC, Auburn Hills, MI (US)

(72) Inventors: Paul S. Van Norman, Auburn Hills, MI (US); Prashant Maurya, Windsor (CA)

(21) Appl. No.: 19/086,294

(22) Filed: Mar. 21, 2025

(51) Int. Cl. B60R 13/10

(52) U.S. Cl. CPC B60R 13/105

(57) ABSTRACT

A license plate mounting assembly includes a mounting body, a fastener having a head at and a threaded portion, and a retainer. The retainer has a front facing the head, a rear, and a threaded opening in which the threaded portion of the fastener is received. The front of the retainer has a first dimension and a second dimension that is greater than the first dimension, and the retainer is adapted to be received through a passage in a body panel of a vehicle that is sized to receive the first dimension of the retainer but which has a dimension less than the second dimension of the retainer. The fastener is rotatable relative to the retainer to alter a distance between the head and the retainer to permit releasable clamping of the mounting body and body panel between the head and the retainer.

### FIELD

The present disclosure relates to a license plate mounting assembly for a vehicle.

### BACKGROUND

Some jurisdictions require vehicles to have a license plate on the front end of the vehicles and some do not. To adapt a vehicle not designed to have a license plate on the front end, holes are drilled into a front body panel to receive fasteners to mount the license plate. When the license plate is removed, the holes are visible and not congruent with the appearance of the front end.

### SUMMARY

In at least some implementations, a license plate mounting assembly for a vehicle includes a mounting body having multiple license plate fastener openings and a front face that is adapted to be overlapped by a license plate, and a rear side adapted to be received adjacent to a vehicle body panel, the mounting body has a mounting opening located in the front face and extending through the mounting body, a fastener having a head at one end and a threaded portion spaced from the head, and a retainer. The retainer has a front facing the head, a rear opposite to the front, and a threaded opening through the front and the rear and in which the threaded portion of the fastener is received. The front of the retainer has a first dimension and a second dimension that is greater than the first dimension, and the retainer is adapted to be received through a passage in a body panel of a vehicle that is sized to receive the first dimension of the retainer. Then the retainer is rotatable with the fastener relative to the body panel to position the front of the retainer along an inner surface of the body panel and oriented so that the second dimension of the retainer is oriented relative to the passage so that part of the front of the retainer overlaps the inner surface of the body panel and prevents the retainer from moving through the passage. The fastener is rotatable relative to the retainer to alter a distance between the head and the retainer to permit releasable clamping of the mounting body and body panel between the head and the retainer.

In at least some implementations, the retainer includes a first stop surface arranged to engage a first portion of the body panel to inhibit rotation of the retainer relative to the body panel and to permit the fastener to be rotated to decrease the distance of the head from the retainer. In at least some implementations, the first stop surface is defined by a flange that extends from the front and toward the head. In at least some implementations, the retainer includes a second stop surface arranged to engage a second portion of the body panel to inhibit rotation of the retainer in an opposite direction and facilitate rotation of the fastener in a direction increasing the distance of the head from the retainer.

In at least some implementations, the first dimension is defined by a first pair of opposite of sides of the front of the retainer. In at least some implementations, the second dimension is defined by a second pair of opposite sides of the front of the retainer.

In at least some implementations, a license plate mounting assembly for a vehicle includes a body panel of the vehicle having an outer surface that defines part of an exterior of the vehicle and an inner surface opposite to the outer surface, the body panel including a passage through the outer surface and the inner surface, the passage having a first end defined by the edges of the inner surface and the first end has a height and a width that is greater than the height;
a mounting body having multiple license plate fastener openings and a front side that is adapted to be overlapped by a license plate, and a rear side opposite to the front side and received adjacent to the outer surface of the body panel, the mounting body has a mounting opening extending through front face and the rear side, a fastener having a head at one end and a shank with a threaded portion spaced from the head, the shank is received through the mounting opening with the head adjacent to the front side of the mounting body, and a retainer. The retainer has a first side, a second side opposite to the first side, and a threaded opening through the first side and the second side and in which the threaded portion of the fastener is received. The first side has a first dimension and a second dimension that is greater than the first dimension, and the first dimension and the second dimension are less than the width of the first end of the passage, and the second dimension is greater than the height of the first end of the passage. The retainer is insertable through the passage in a first orientation and then the retainer is rotatable to a second orientation in which part of the retainer extends beyond the first end of the passage and overlaps the inner surface of the body panel to prevent the retainer from moving through the passage in the second orientation. The fastener is rotatable relative to the retainer to alter a distance between the head and the retainer to permit releasable clamping of the mounting body and body panel between the head and the retainer.

In at least some implementations, the body panel is a front fascia of the vehicle and the passage defines one of multiple openings that define an orderly array of openings in the front fascia. In at least some implementations, the passage is evenly spaced from multiple other openings of the multiple openings and a second end of the passage defined at the outer surface of the front fascia has the same dimensions of at least one other of the multiple openings.

In at least some implementations, the body panel includes a first stop surface extending away from the inner surface and arranged to be engaged by the retainer during a rotation of the rotation about the axis of the shank at least in a first direction tending to decrease a distance between the head and the retainer. In at least some implementations, the body panel includes a second stop surface extending from the inner surface and arranged to engage an opposite side of the retainer as the first stop surface. In at least some implementations, the first stop surface is parallel to an edge of the first end of the passage. In at least some implementations, the first stop surface is located to be engaged by the retainer upon rotation of the retainer in a direction caused by rotation of the fastener in a direction tending to increase a distance between the head and the retainer.

In at least some implementations, the retainer includes a flange extending from the front and arranged to axially overlap a surface of the body panel, where axially is with reference to the axis of the shank. In at least some implementations, a free end of the flange is located axially between the first end of the passage and an opposite second end of the passage defined at least partly by the outer surface of the body panel.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of part of a front of a vehicle 10 including a removable front license plate mounting assembly;

FIG. 2 is an enlarged fragmentary view showing the license plate mounting assembly with a license plate removed;

FIG. 3 is a diagrammatic sectional view showing the license plate mounting assembly;

FIG. 4 is a view of a rear side of a vehicle body panel showing a fastener and a retainer of the license plate mounting assembly with the retainer in a first orientation; and

FIG. 5 is a view similar to FIG. 4 showing an installed position of the fastener and retainer.

### DETAILED DESCRIPTION

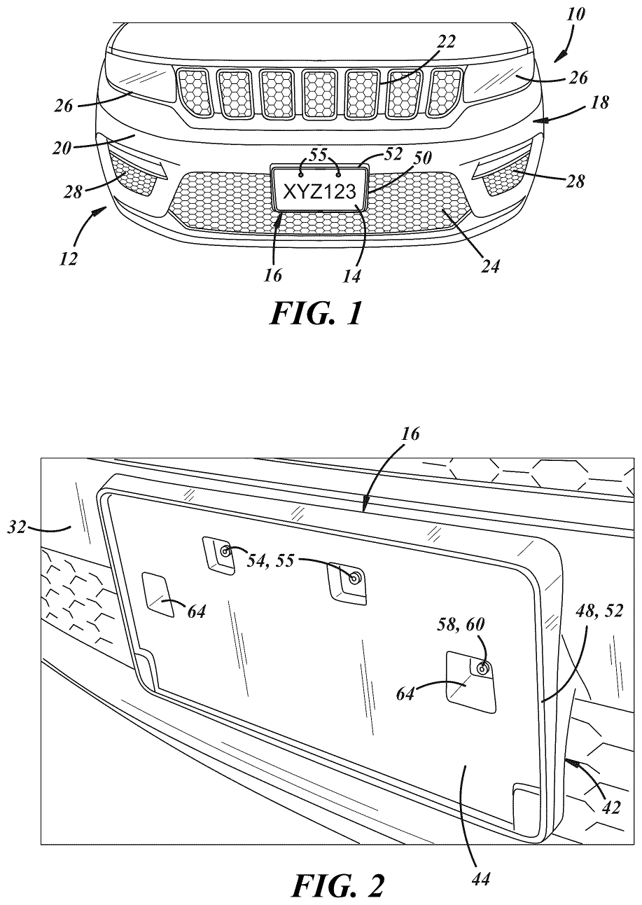

Referring in more detail to the drawings, FIG. 1 shows a vehicle 10, and more particularly, part of a front end 12 of a sport-utility vehicle (SUV), in the illustrated example. The vehicle front end 12 includes a license plate 14 mounted on a license plate mounting assembly 16 that is connected to a front body panel, sometimes called a front fascia or bumper, which may be part of an assembly of body panels 18 and trim components. For example, the front of the vehicle 10 shown in FIG. 1 includes the front bumper panel 20 that is received between an upper grill 22 and a lower grill 24, and adjacent to headlight assemblies 26, and lower side grill assemblies 28. The front end 12 could include additional lights, like fog lights, and more grills or a single grill could be provided, by way of non-limiting examples of alternate arrangements.

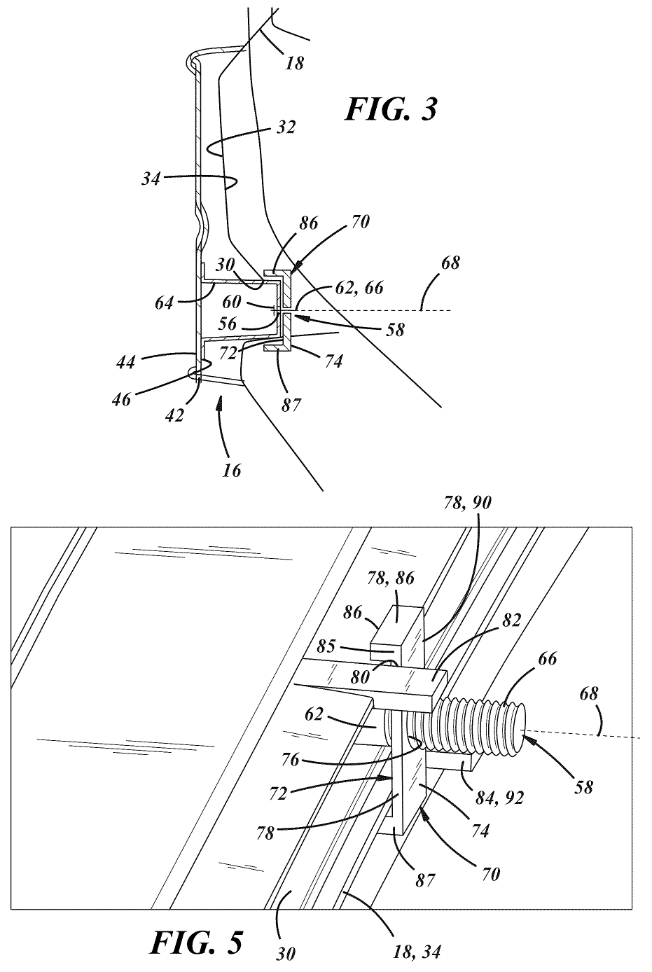

In at least some implementations, one or more grills or other body panels 18 (e.g. a front bumper or front fascia) includes, as shown in FIGS. 3-5, one or more passages 30 extending from an outer surface 32 that defines part of the exterior of the vehicle 10, and through an inner surface 34 that is opposite to the outer surface 32. The passage(s) 30 may be decorative or functional, such as to permit airflow to a component (e.g. a radiator, engine, brake assembly, etc) behind a grill 22, 24, 28 (e.g. a body panel 18). For ease of description, one passage 30 will be described and it is understood that additional, similar passages may be provided. In at least some implementations, as shown in FIG. 3, the passage 30 has a first end 36 defined by the edges of the inner surface 34, and the first end 36 has a first dimension (called height H herein) and a second dimension (called width W herein) that is greater than the height H. The passage 30 may be one of multiple openings 38 through the body panel 18, and the multiple openings 38 may define an orderly array of openings 38 in the front end body panels 18, such as is common in some vehicle grills 22, 24. 28, by way of one, non-limiting example. The orderly array of openings 38 may include openings of different shapes and sizes in a predetermined pattern, or of uniform size and shape, as desired. In at least some implementations, the passage 30 is evenly spaced from multiple other passages 30 or openings 38 of the multiple openings 38 in the body panel 18. Further, in at least some implementations, the passage 30 includes a second end 40 defined at the outer surface 32 of the front fascia, and the second end 40 has the same dimensions of at least one other opening 38 or passage 30 of the multiple openings 38.

In some jurisdictions but not others, license plates are needed on the front end 12 of the vehicle 10. In at least some implementations, the mounting assembly 16 is constructed and arranged so that it can be connected to the vehicle 10 via existing structures of the vehicle 10, and without requiring holes to be drilled through a vehicle panel 18 or component. In this way, the mounting assembly 16 can be removed from the vehicle 10 when it is not needed to mount a license plate 14 to the front of the vehicle 10 and extraneous holes are not visible in the body panels 18.

As shown in FIG. 2, the mounting assembly 16 includes a mounting body 42 having a front side 44 facing outwardly from the vehicle 10 and an opposite rear side 46 adjacent to the vehicle 10. The front side 44 may be sized for receipt of a license plate 14 with a rear face of the license plate 14 received against at least part of the front side 44, and with a front face of the license plate 14 open to the exterior and in view from the front end 12 of the vehicle 10. The front side 44 of the mounting body 42 may have a size and shape so that a perimeter 48 of the front side 44 is at least as large as and overlaps a perimeter 50 (FIG. 1) or edge of the license plate 14. The perimeter 48 of the front side 44 may include or be defined by a rim 52 that may extend outwardly away from the front side 44 farther than the license plate 14 (e.g. greater distance than the thickness of the license plate 14). In this way, the edge/perimeter of the license plate 14 may be overlapped and protected from being engaged by objects (e.g. car wash brushes or the like) to inhibit objects from getting snagged on or bending the license plate 14. To facilitate connecting the license plate 14 to the mounting body 42, the mounting body 42 includes one or more fastener openings 54 formed in the front side 44 and arranged to receive bolts 55 (FIGS. 1 and 2) passed through holes in the license plate 14.

As shown in FIGS. 2 and 3, to enable the mounting body 42 to be coupled to the vehicle 10, the mounting body 42 has at least one mounting opening 56 located in the front side 44 and extending through the mounting body 42. In at least some implementations, a separate fastener 58 is passed through each mounting opening 56. The fasteners 58 each have a head 60 at a first end and a shank 62 extending from the head 60 and through the mounting opening 56. The head 60 is larger than an adjacent portion of the mounting opening 56 such that the head 60 engages the mounting body 42 and does not pass through the mounting opening 56. In this regard, the head 60 may be received within a counterbore 64 or enlarged area surrounding the mounting opening 56 so that the head 60 is recessed relative to the front side 44. At least part of the shank 62 is threaded and extends beyond the rear face of the mounting body 42. The threaded part 66 of the shank 62 may extend to an end of the shank 62 that defines a second end of the fastener 58, opposite to the head 60/first end. The shank 62 may be cylindrical and rotates about an axis of rotation 68 which may be a center axis of the shank 62.

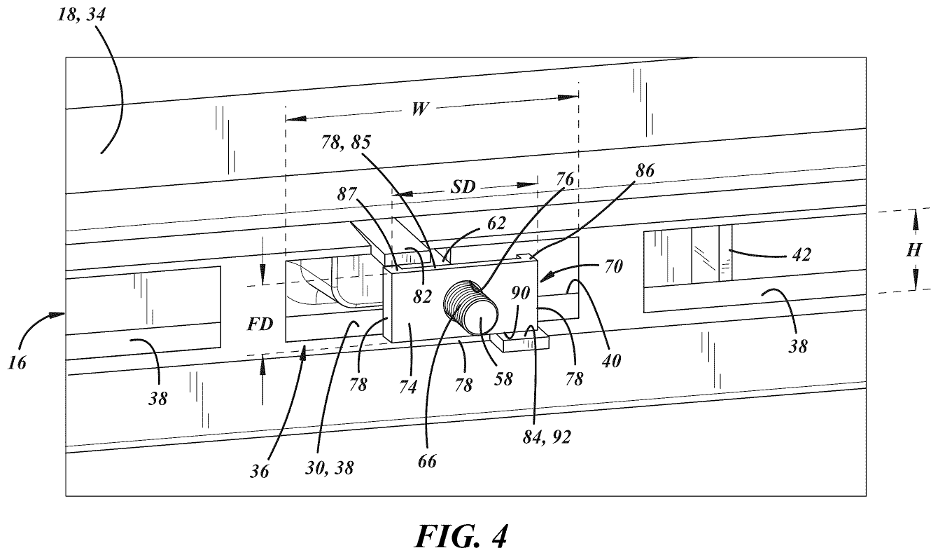

To enable the fastener 58 and mounting body 42 to be releasably and securely fastened to the vehicle 10, as shown in FIGS. 3-5, the mounting assembly 16 includes a separate retainer 70 for each fastener 58. The retainer 70 has a first side or front 72, a second side or rear 74 opposite to the front, and a threaded opening 76 through the front 72 and the rear 74, and in which the threaded portion 66 of the fastener 58 is received. The retainer 70 has sidewalls or edges 78 that extend between the front 72 and rear 74, and which define a perimeter of the retainer 70. As shown in FIG. 4, the retainer 70 has a first dimension FD and a second dimension SD that is greater than the first dimension FD. In the example shown in the drawings, the retainer 70 has a generally rectangular periphery and the first dimension FD is defined between a first pair of opposite sidewalls or edges, and the second dimension SD is defined between a second pair of opposite sidewalls or edges.

To releasably retain the mounting body 42 to the vehicle 10, each retainer 70 is adapted to be received through a passage 30 in the vehicle body panel 18, and then the retainer 70 is adapted to be rotated to a position in which the front 72 of the retainer 70 overlaps the inner surface 34 of the body panel 18 at the periphery of the first end 36 of the passage 30 to inhibit or prevent removal of the retainer 70 from behind the body panel 18. In this way, the first dimension FD of the retainer 70 is less than the height H of the passage 30, and the second dimension SD is less than the width W and greater than the height H, at least at the first end 36 of the passage 30. Thus, when the retainer 70 is oriented as shown in FIG. 4, so that the first dimension FD is generally aligned or parallel to the width W of the passage 30 and the second dimension SD is generally oriented or aligned relative to the width W, the retainer 70 can pass into and through the passage 30. Thereafter, when the retainer 70 is rotated about the axis of rotation 68 to the position shown in FIG. 5, the second dimension SD of the retainer 70 may be oriented in the direction of the height H of the passage 30 and part of the retainer 70 will then overlap the body panel 18 outboard of the first end 36 of the passage 30. In this orientation, the retainer 70 cannot be pulled through the passage 30 and the retainer 70 is maintained at the first end 36 of the passage 30 and adjacent to the inner surface 34 of the body panel 18.

In this orientation, rotation of the fastener 58 relative to the retainer 70 alters the distance between the fastener head 60 and the retainer 70 to permit releasable clamping of the mounting body 42 and body panel 18 between the head 60 and the retainer 70. That is, rotation of the fastener 58 in one direction relative to the retainer 70 will decrease the distance between the head 60 and the retainer 70 to permit clamping of the mounting body 42 to the body panel 18. And rotation of the fastener 58 in the other direction relative to the retainer 70 will increase the distance between the head 60 and the retainer 70 to permit releasing the mounting panel from the body panel 18.

In at least some implementations, the body panel 18 includes at least one stop surface 80 arranged to be engaged by the retainer 70 to limit rotation of the retainer 70 relative to the body panel 18. In the example shown in FIGS. 4 and 5, the body panel 18 includes a first projection 82 that defines the first stop surface 80 and is located adjacent to the first end 36 of the passage 30. The first projection 82 may extend from the inner surface 34 and be oriented so that the first projection is generally parallel to the first passage 30, and does not overlap of cover the first end 36 of the passage 30 (e.g. does not interfere with insertion of the retainer 70 through the passage 30, and the first projection may be parallel to an edge of the body panel 18 that defines the first end 36 of the first passage 30. The first projection 82 is arranged to be engaged by the retainer 70 when the fastener 58 is rotated in the first direction, to reduce the distance between the head 60 and the retainer 70. The body panel 18 may also include a second projection 84, spaced from the first projection 82 and arranged to be engaged by the retainer 70 (e.g. define a second stop surface of the body panel 18) when the fastener 58 is rotated in the second direction, to increase the distance between the head 60 and the retainer 70.

In at least some implementations, the retainer 70 includes a first stop surface 85 arranged to engage the first projection 82 or other portion of the body panel 18 to inhibit rotation of the retainer 70 relative to the body panel 18, and the first stop surface 85 may be defined by a sidewall 78 or a flange 86 that extends axially (relative to the axis of rotation 68) from the front 72 and toward the head 60. The flange 86 may instead be arranged to overlap, in the axial direction, a surface of a flange or rim or projection of the body panel 18 that defines part of or is adjacent to the first end 36 of the passage 30. The flange 86, when axially overlapped on the body panel 18, has a free end 88 thereof that is outboard of the passage and located axially between the first end 36 and the second end 40 of the passage 30, and may inhibit unintended rotation of the retainer 70 relative to the body panel 18, such as may occur due to vibrations or other forces acting on the retainer 70 or other part of the mounting assembly 16. In at least some implementations, the front 72 of the retainer 70 is defined by a flat or planar face that extends radially and has two flanges 86,87, one at each of two opposite ends. In assembly, the front 72 is engaged by part of the inner surface 34 of the body panel 18 and the flanges 86,87 axially overlap the body panel 18, providing a secure connection.

Similarly, the retainer 70 may include a second stop surface 90 arranged to engage a second stop surface 92 of the body panel 18 that may be defined by the second projection 84 or another portion of the body panel 18, to inhibit rotation of the retainer 70 and facilitate rotation of the fastener 58 in a direction increasing the distance of the head 60 from the retainer 70. The second stop surface 90 may be defined by, or the retainer 70 may otherwise include a second flange 87, at an opposite end of the retainer 70 as the first flange 86. The second flange 87 may be arranged to axially overlap a different portion of the body panel 18 (e.g. a rim or flange or projection of the body panel 18) as noted above with regard to the first flange 86, to improve the coupling between the retainer 70 and the body panel 18 and ensure a secure connection of the mounting assembly 16 to the vehicle 10.

By utilizing a passage 30 or opening in the body panel 18 that looks like other openings 38 in the body panel 18, such as by being consistently spaced and sized relative to other openings 38, and by not requiring additional openings in the body panel 18 by which the mounting assembly 16 is coupled to the vehicle 10, removing the mounting assembly 16 and license plate 14 from the vehicle 10 does not leave open holes that are inconsistent with the appearance of the front end 12 of the vehicle 10. Additionally, the retainer 70 may be arranged to be easily installed behind the body panel 18, against the inner surface 34 thereof, and to be easily released from the body panel 18, without damaging the body panel 18. Stop surfaces may be provided to control/limit rotation of the retainer 70 as the fastener 58 is rotated, and the retainer 70 may overlap part of the body panel 18 in the installed position, to improve the connection between them and inhibit unintended rotation of the retainer 70 which might loosen the connection. The retainer 70 permits the fastener 58 to be tightened sufficiently to securely clamp the mounting body 42 to the body panel 18 between the head 60 of the fastener 58 and the retainer 70. This inhibits vibration or relative movement of the mounting body 42 relative to the body panel 18 to reduce noise and inhibit scratching or rubbing of the bodies.

What is claimed is:

1. A license plate mounting assembly for a vehicle, comprising:
a mounting body having multiple license plate fastener openings and a front face that is adapted to be overlapped by a license plate, and a rear side adapted to be received adjacent to a vehicle body panel, the mounting body has a mounting opening located in the front face and extending through the mounting body;
a fastener having a head at one end and a threaded portion spaced from the head; and
a retainer having a front facing the head, a rear opposite to the front, and a threaded opening through the front and the rear and in which the threaded portion of the fastener is received, the front has a first dimension and a second dimension that is greater than the first dimension, wherein the retainer is adapted to be received through a passage in a body panel of a vehicle that is sized to receive the first dimension of the retainer, and then the retainer is rotatable with the fastener relative to the body panel to position the front of the retainer along an inner surface of the body panel and oriented so that the second dimension of the retainer is oriented relative to the passage so that part of the front of the retainer overlaps the inner surface of the body panel and prevents the retainer from moving through the passage, and the fastener is rotatable relative to the retainer to alter a distance between the head and the retainer to permit releasable clamping of the mounting body and body panel between the head and the retainer.

2. The assembly of claim 1 wherein the retainer includes a first stop surface arranged to engage a first portion of the body panel to inhibit rotation of the retainer relative to the body panel and to permit the fastener to be rotated to decrease the distance of the head from the retainer.

3. The assembly of claim 2 wherein the first stop surface is defined by a flange that extends from the front and toward the head.

4. The assembly of claim 2 wherein the retainer includes a second stop surface arranged to engage a second portion of the body panel to inhibit rotation of the retainer in an opposite direction and facilitate rotation of the fastener in a direction increasing the distance of the head from the retainer.

5. The assembly of claim 1 wherein the first dimension is defined by a first pair of opposite of sides of the front of the retainer.

6. The assembly of claim 5 wherein the second dimension is defined by a second pair of opposite sides of the front of the retainer.

7. A license plate mounting assembly for a vehicle, comprising:
a body panel of the vehicle having an outer surface that defines part of an exterior of the vehicle and an inner surface opposite to the outer surface, the body panel including a passage through the outer surface and the inner surface, the passage having a first end defined by the edges of the inner surface and the first end has a height and a width that is greater than the height;
a mounting body having multiple license plate fastener openings and a front side that is adapted to be overlapped by a license plate, and a rear side opposite to the front side and received adjacent to the outer surface of the body panel, the mounting body has a mounting opening extending through front face and the rear side;
a fastener having a head at one end and a shank with a threaded portion spaced from the head, the shank is received through the mounting opening with the head adjacent to the front side of the mounting body; and
a retainer having a first side, a second side opposite to the first side, and a threaded opening through the first side and the second side and in which the threaded portion of the fastener is received, the first side has a first dimension and a second dimension that is greater than the first dimension, wherein the first dimension and the second dimension are less than the width of the first end of the passage, and the second dimension is greater than the height of the first end of the passage, and wherein the retainer is insertable through the passage in a first orientation and then the retainer is rotatable to a second orientation in which part of the retainer extends beyond the first end of the passage and overlaps the inner surface of the body panel to prevent the retainer from moving through the passage in the second orientation, and the fastener is rotatable relative to the retainer to alter a distance between the head and the retainer to permit releasable clamping of the mounting body and body panel between the head and the retainer.

8. The assembly of claim 7 wherein the body panel is a front fascia of the vehicle and the passage defines one of multiple openings that define an orderly array of openings in the front fascia.

9. The assembly of claim 8 wherein the passage is evenly spaced from multiple other openings of the multiple openings and a second end of the passage defined at the outer surface of the front fascia has the same dimensions of at least one other of the multiple openings.

10. The assembly of claim 7 wherein the body panel includes a first stop surface extending away from the inner surface and arranged to be engaged by the retainer during a rotation of the rotation about the axis of the shank at least in a first direction tending to decrease a distance between the head and the retainer.

11. The assembly of claim 10 wherein the body panel includes a second stop surface extending from the inner surface and arranged to engage an opposite side of the retainer as the first stop surface.

12. The assembly of claim 10 wherein the first stop surface is parallel to an edge of the first end of the passage.

13. The assembly of claim 10 wherein the first stop surface is located to be engaged by the retainer upon rotation of the retainer in a direction caused by rotation of the fastener in a direction tending to increase a distance between the head and the retainer.

14. The assembly of claim 7 wherein the retainer includes a flange extending from the front and arranged to axially overlap a surface of the body panel, where axially is with reference to the axis of the shank.

15. The assembly of claim 14 wherein a free end of the flange is located axially between the first end of the passage and an opposite second end of the passage defined at least partly by the outer surface of the body panel.
